(19) United States
(12) Patent Application Publication
(10) Pub. No.: US 2026/0152301 A1
(43) Pub. Date: Jun. 4, 2026

(54) HIGH POWER RECTENNA ARRAY

(71) Applicant: GuRu Wireless, Inc., Pasadena, CA (US)

(72) Inventors: Behrooz Abiri, Pasadena, CA (US); Amirreza Safaripour, Pasadena, CA (US)

(21) Appl. No.: 19/272,941

(22) Filed: Jul. 17, 2025

Related U.S. Application Data
(60) Provisional application No. 63/672,503, filed on Jul. 17, 2024.

(51) Int. Cl. B64U 50/35; B64U 10/14; B64U 10/25; B64U 20/80; H01Q 1/24; H01Q 9/04; H01Q 9/16; H01Q 21/06; H02J 50/27; H02J 50/40

(52) U.S. Cl. CPC B64U 50/35; B64U 10/14; B64U 10/25; B64U 20/80; H01Q 1/248; H01Q 9/0407; H01Q 9/16; H01Q 21/062; H02J 50/27; H02J 50/402; B64U 2201/104

(57) ABSTRACT

A wireless power rectifying system includes, in part, a multitude of boards. Each board includes an array of antenna elements and an array of rectifying circuits each associated with a different one of the array of antenna elements. Each rectifying circuit is adapted to convert an RF signal received by the associated antenna element array to DC voltage. The spacing between each pair of adjacent boards is in a range defined by λ/20 to λ/2, where λ is the wavelength of the received RF signal.

### RELATED APPLICATION

The present application claims benefit under 35 USC 119(e) of U.S. Application No. 63/672,503, filed Jul. 17, 2024, the content of which is incorporated herein by reference in its entirety.

### TECHNICAL FIELD

The present application relates to wireless power transfer via electromagnetic radiation, and more particularly to a high density an array of receive antennas for receiving and converting the electromagnetic radiation to a DC voltage.

### BACKGROUND

Active RF lensing that focuses RF power generated by a phased array system onto a relatively small focal point has enabled high power millimeter-wave wireless power transfer (WPT) over relatively long distances. RF lensing technique benefits from scaling up the size of the transmitter. A larger transmitter array has an enhanced focusing ability and is capable of supplying more RF power. The high intensity and high-power focal spot achieved using a phased array transmitter enables the delivery of sufficient power for use in applications such as autonomous robots, utility task vehicles, unmanned aerial vehicles, unmanned surface vehicles. Such applications require a small and low weight receive antenna to minimize impact on the vehicles' maneuvering, aerodynamics and other performance parameters.

The millimeter-wave power received by an autonomous vehicle needs to be converted into usable DC power. For a wireless power transfer system, a high power receive antenna together with an RF-to-DC rectifier, collectively and alternatively referred to herein as a rectenna, is needed. High power RF rectification poses many challenges at millimeter-wave frequencies due to the reduced breakdown voltage and relatively small junction area of high frequency semiconductor devices.

Semiconductor substrates such as GaN and SiC provide higher breakdown voltages, however they suffer from the excessive heat at the small junction of the device. In another approach, the power received by the antenna is split, by power dividers, into several channels and delivered to multiple rectifiers. However, power dividers are lossy. Another known technique uses multiple patch antennas and spreads the focal spot of the RF beam over a larger area such that each antenna receives a smaller amount of RF power. However, such a technique suffers from the increased size and weight of the receiver as a larger focal spot is used.

### SUMMARY

A wireless power rectifying system, in accordance with one embodiment of the present disclosure, includes, in part, a multitude of boards each including, on a first side thereof an array of antenna elements, and an array of rectifying circuits each associated with a different one of the array of antenna elements. Each rectifying circuit is adapted to convert to a DC voltage, an RF signal received by the rectifying circuit's associated antenna element. Each rectifying circuit is disposed in a package having a height H. The distance between a first one of the boards and a second one of the boards is in the range defined by (H+λ/20) to (H+λ/2), where λ is the wavelength of the RF signal.

In one embodiment, the array of antenna elements on each board is a two-dimensional array of dipole antennas. In one embodiment, each board is a printed circuit board (PCB). The array of antenna elements on each such board is a one-dimensional array of edge emitting antennas. In one embodiment, a first subset of the multitude of boards includes, in part, on a second side thereof a second array of antenna elements and a second array of rectifying circuits each associated with a different one of the second array of antenna elements of the second array.

A wireless power rectifying system, in accordance with one embodiment of the present disclosure, includes, in part, N boards arranged in parallel to form a stack. Each board includes, in part, on a first side thereof an array of antenna elements, and an array of rectifying circuits each associated with a different one of the array of antenna elements. Each rectifying circuit is adapted to convert to a DC voltage, an RF signal received by the rectifying circuit's associated antenna element. The distance d₁ between first and second of the N boards positioned near a center of the stack is smaller than a distance d₂ between third and fourth of the N boards positioned away from the center of the stack. The distance d₂ is smaller than a distance d₃ between fifth and sixth of the N boards positioned near either ends of the stack. In one embodiment, the array of antenna elements on each board is a two-dimensional array of dipole antennas. In one embodiment, each board is a PCB board and the array of antenna elements on each board is a one-dimensional array of edge emitting antennas.

A wireless power rectifying system, in accordance with one embodiment of the present disclosure, includes, in part, a multitude of boards. Each board includes an array of antenna elements, and an array of rectifying circuits each associated with a different one of the array of antenna elements. Each rectifying circuit is adapted to convert to a DC voltage, an RF signal received by the rectifying circuit's associated antenna element. The spacing between each pair of adjacent boards is in the range defined by (λ/20) to (λ/2), where λ is the wavelength of the RF signal. In one embodiment, the DC voltage rectified by each rectifier is received along an edge of a board in which the rectifier is disposed. In one embodiment, the DC voltage rectified by each rectifier is received from a backside of a board in which the rectifier is disposed

A wireless power rectifying system, in accordance with one embodiment of the present disclosure, includes, in part, a first multitude of boards and a second multitude of boards. Each of the first multitude of boards includes, in part, an array of antenna elements, and an array of rectifying circuits each associated with a different one of the array of antenna elements. Each rectifying circuit is adapted to convert to a DC voltage, an RF signal received by the rectifying circuit's associated antenna element. and adapted to convert an RF signal received by the associated antenna element array to a DC voltage. Each of the second multitude of boards includes, in part, an array of antenna elements, and an array of rectifying circuits each associated with a different one of the array of antenna elements of the second multitude of boards. Each rectifying circuit of the second multitude of boards is adapted to convert to a DC voltage, an RF signal received by the rectifying circuit's associated antenna element. The first multitude of boards is arranged in parallel along a first axis. The second multitude of boards is arranged in parallel along a second axis that is substantially perpendicular to the first axis.

In one embodiment, the second multitude of boards is positioned either above or below the first multitude of boards. In one embodiment, each antenna of the first and second multitude of boards is a dipole antenna. In one embodiment, each of the second multitude of boards includes a multitude of slots each adapted to receive a different one of the multitude of the first boards.

An unmanned aerial vehicle (UAV) includes, in part, a multitude of boards each including, on a first side thereof, an array of antenna elements and an array of rectifying circuits each associated with a different one of the array of antenna elements. Each rectifying circuit is adapted to convert to a DC voltage, an RF signal received by the rectifying circuit's associated antenna element.

In one embodiment of the UAV, the multitude of boards are positioned below the UAV's body to receive the RF signal transmitted from a ground-based transmitter. In one embodiment, the UAV is a fixed-wing UAV. In one embodiment of the UAV, the multitude of boards are positioned above the UAV's body to receive the RF signal transmitted from one or more satellites orbiting the earth, or from one or more high-altitude balloons, or form one or more transmitters stationed on a mountain top having an elevation higher than an altitude of the UAV.

In one embodiment, the UAV includes a frame surrounding the multitude of boards. The UAV frame includes, in part, a multitude of patch antennas on the frame's exterior surface. In one embodiment, the UAV include, in part, a multitude of sensors each adapted to measure a power of the received RF signal and supply the measured power to a transmitter transmitting the RF signal so as to cause the transmitter to steer the RF signal toward the multitude of boards during flight. In one embodiment, the UAV includes, in part, a multitude of sensors each adapted to measure a power of the received RF signal, and a flight controller adapted to maintain the UAV locked to a transmitter transmitting the RF signal during flight in accordance with the measurements made by the sensors.

A method, in accordance with one embodiment of the present disclosure, includes, in part, receiving an RF signal via a multitude of boards. Each board includes on a first side thereof an array of antenna elements and an array of rectifying circuits each associated with a different one of the array of antenna elements. Each rectifying circuit is disposed in a package having a height H. The distance between a first one of the multitude of boards and a second one of the multitude is in a range defined by (H+λ/20) to (H+λ/2), where λ is the wavelength of the received RF signal. The method further includes, in part, converting, via each array of the rectifying circuits, the RF signal received by the rectifying circuit's associated array of antenna elements to a DC voltage.

A method, in accordance with one embodiment of the present disclosure, includes, in part, receiving an RF signal via a multitude of boards. Each board includes on a first side thereof an array of antenna elements and an array of rectifying circuits each associated with a different one of the array of antenna elements. The distance between a first one of the multitude of boards and a second one of the multitude is in a range defined by (λ/20) to (λ/2), wherein λ is the wavelength of the received RF signal. The method further includes, in part, converting, via each array of the rectifying circuits, the RF signal received by the rectifying circuit's associated array of antenna elements to a DC voltage.

A method of powering an unmanned aerial vehicle (UAV) wirelessly, includes, in part, receiving an RF signals via a multitude of boards disposed on the UAV. Each board includes, in part, an array of antenna elements and an array of rectifying circuits each associated with a different one of the array of antenna elements. The method further includes, in part, converting, via each array of the rectifying circuits, the RF signal received by the rectifying circuit's associated array of antenna elements to a DC voltage. IN one embodiment, the array of antenna elements and the associated array of rectifying circuits on each board is a two-dimensional array.

### BRIEF DESCRIPTION OF THE DRAWINGS

FIG. 1 is a schematic diagram of a two-dimensional array of rectennas positioned along a multitude of rows and columns, in accordance with one exemplary embodiment of the present disclosure.

FIG. 2 is a schematic diagram of a three-dimensional array of rectennas, in accordance with another exemplary embodiment of the present disclosure.

FIG. 3 is a side view of the three-dimensional array of rectennas shown in FIG. 2, in accordance with one embodiment of the present disclosure.

FIG. 4 is a schematic diagram of a three-dimensional array of rectennas, in accordance with another embodiment of the present disclosure.

FIG. 5A is a sideview of a multitude boards each including a one or two dimensional array of rectennas, in accordance with another embodiment of the present disclosure.

FIG. 5B is a sideview of a multitude of boards each including a one or two dimensional array of rectennas, in accordance with another embodiment of the present disclosure.

FIG. 5C is a sideview of a multitude of boards each including a one or two dimensional array of rectennas on both sides, in accordance with one embodiment of the present disclosure.

FIG. 6 is a perspective view of a dual-polarized array of rectennas, in accordance with one embodiment of the present disclosure.

FIG. 7 is a perspective view of a dual-polarized array of rectennas, in accordance with another embodiment of the present disclosure.

FIG. 8 shows a multitude of boards forming a three dimensional array of rectennas in which the generated DC voltages are received from terminals positioned along a surface substantially perpendicular to staking direction of the boards, in accordance with one embodiment of the present disclosure.

FIG. 9 shows a multitude of boards forming a three dimensional array of rectennas in which the generated DC voltages are received from terminals positioned along end points of the boards, in accordance with one embodiment of the present disclosure.

FIG. 10 shows a UAV that includes an array of rectennas positioned on a bottom surface of the UAV to receive wireless power transmitted by one or more Earth-based RF transmitters, in accordance with one embodiment of the present disclosure.

FIG. 11 shows a UAV that includes an array of rectennas positioned on a top surface of the UAV to receive wireless power transmitted by one or more satellites orbiting the Earth, in accordance with one embodiment of the present disclosure.

FIG. 12 shows a UAV that includes a multitude of boards each having an array of rectennas and so positioned as to enables airflow from the propellors to cool the array of rectennas, in accordance with one embodiment of the present disclosure.

FIG. 13 shows a fixed-wing UAV that includes a multitude of boards each having an array of rectennas and positioned along a bottom side of the UAV, in accordance with one embodiment of the present disclosure.

FIG. 14 is a simplified schematic diagram of a number of components of an UAV, in accordance with one embodiment of the present disclosure.

FIG. 15 is a simplified schematic diagram of a UAV and its various components, in accordance with one embodiment of the present disclosure.

FIG. 16 shows a UAV that includes a multitude of boards each having an array of rectennas, as well as a frame with an exterior wall which includes a multitude of patch antennas, in accordance with one embodiment of the present disclosure.

FIG. 17 shows a UAV that includes a multitude of boards each having an array of rectennas positioned on a bottom surface of the UAV, as well as a multitude of RF sensors disposed in the vicinity of the boards, in accordance with one embodiment of the present disclosure.

### DETAILED DESCRIPTION

Aspects of the present disclosure relate to a tightly coupled and dense array of rectennas that increase the density of power recovery for any given form factor. Each rectenna is adapted to convert an RF signal received by the rectenna's associated receive antenna element into a DC voltage. Embodiments of the present disclosure provide for splitting the received RF power and feeding multiple rectifiers of the rectennas array without the need to increase the focal spot size of the received RF power and the rectenna size.

An array of rectennas, in accordance with embodiments of the present disclosure, may be formed using a number of different antenna elements (alternatively referred to as antennas), such as dipole antenna, slot antenna, loop antenna, edge emitting antenna, Vivaldi antenna, patch antenna, and the like. The array of rectennas, which may be a one-dimensional array, a two-dimensional array, or a three dimensional array, is tightly packed so as to increase the density of power recovery.

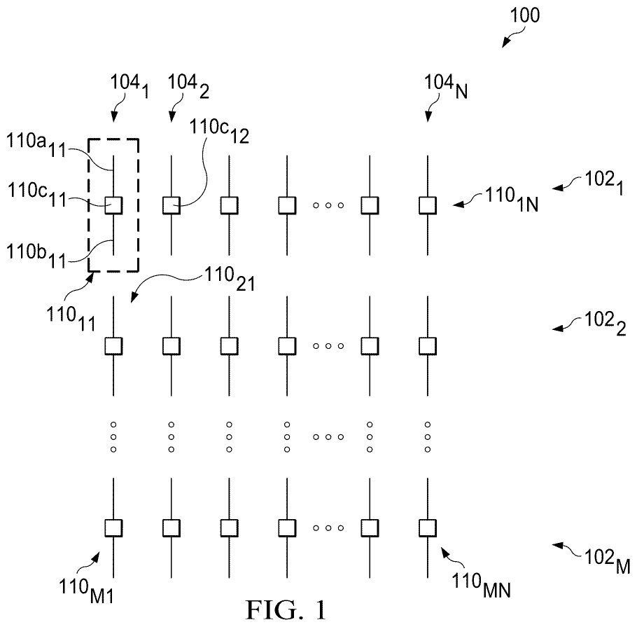

FIG. 1 is a schematic diagram of a two-dimensional array 100 of rectennas 110ᵢⱼ positioned along M rows 102ᵢ and N columns 104ⱼ, where i is a row index ranging from 1 to M and j is a column index ranging from 1 to N, and where M and N are integers greater than 1, in accordance with one exemplary embodiment of the present disclosure. Each row 102ᵢ is shown as including N rectennas 110_{iN}N. For example, first row 102₁ is shown as including N rectennas 110₁₁,110₁₂ . . . 110_{1N}. Each column 104ⱼ is shown as including M rectennas 110_{Mj}. For example, first column 104₁ is shown as including M rectennas 110₁₁, 110₂₁ . . . 110_{M1}. In the example shown in FIG. 1, each rectenna 110ᵢⱼ is shown as including a dipole antenna having a first arm and a second arm and a rectifying circuit adapted to convert the RF signal received by the associated dipole antenna to a DC voltage. For example, rectenna 110₁₁ is shown as including a rectifying circuit 110c₁₁, and dipole antenna having a first arm 110a₁₁ and a second arm 110b₁₁. Rectifying circuit 110c₁₁ converts the RF signal received by the dipole antenna having arms 110a₁₁ and 110b₁₁ to a DC voltage. In one embodiment, the spacing between each pair of adjacent rectifying circuits disposed in the same row, such as rectifying circuits 110c₁₁ and 110c₁₂, is between one-twentieth to half of the wavelength of the RF signal being received by an antennas.

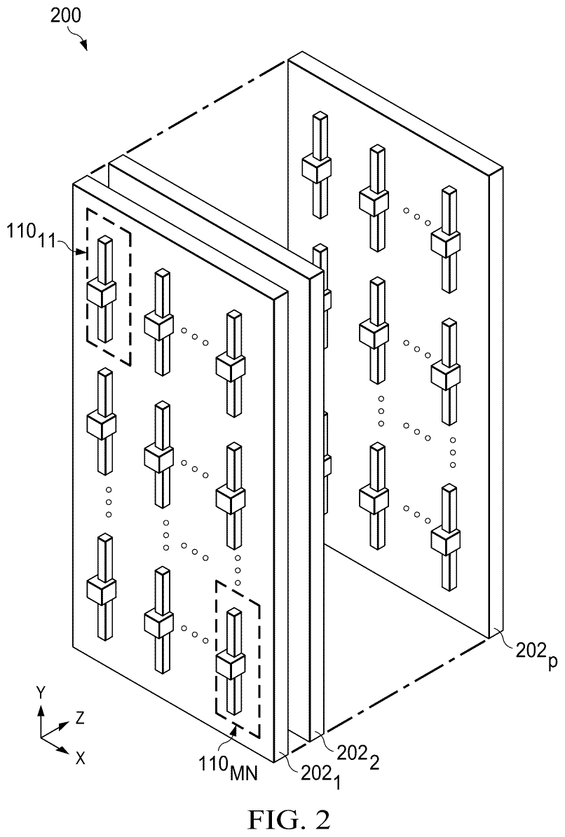

FIG. 2 is a schematic diagram of a three-dimensional array 200 of rectennas 110ᵢⱼₖ, in accordance with another exemplary embodiment of the present disclosure. Array 200 of rectennas is disposed along P boards 202₁, 202₂ . . . 202ₚ that are shown as being stacked along the z-direction. In one embodiment, each board 202ₖ, where k is an index ranging from 1 to P, includes a two-dimensional array of rectennas similar to that shown in FIG. 1. In accordance with one embodiment of the present disclosure, the number of rectennas that can fit in any given volume of space, is limited the by the thickness of the boards as well as the spacing between adjacent boards.

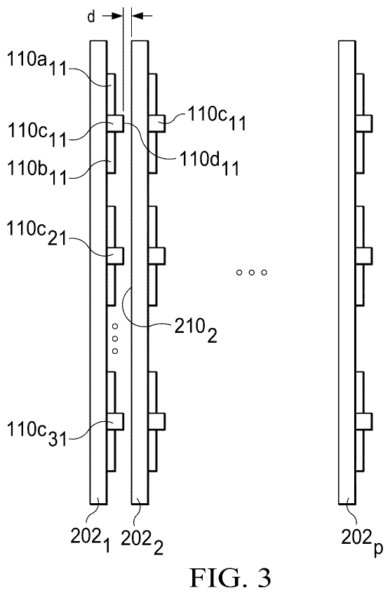

FIG. 3 is a side view of rectenna array 200 of FIG. 2, showing three of the M boards, namely boards 202₁, 202₂ and 202_{P} of rectenna array 200. To ensure high packing and RF recovery density, in one embodiment, the spacing d between the top surface 110d₁₁ of the package housing, for example, rectifying circuit 110c₁₁ of rectenna 110₁₁ of board 202₁ and the back surface 210₂ of adjacent board 202₂, is selected to be as small as possible such that spacing d is substantially zero and may only be limited by the airflow to dissipate the heat generated by the rectifying circuit. In other embodiments, the spacing d may be between 1/20 to ½ of the wavelength λ of the received RF signal. Because the rectifying circuits are distributed throughout the boards (also referred to herein as blades) embodiments of the present disclosure avoid heat concentration and the associated problems of using large heat sinks and other cooling equipment that would be otherwise required if a central rectifying circuit were to be used to generated a DC voltage from the RF signals received by the antennas of the rectenna array. Using an array of rectennas that includes an array of distributed antennas and an array of distributed rectifying circuits eliminates localized heat between the boards, in addition to providing a power density that is inversely proportional to the spacing between the adjacent boards of the array.

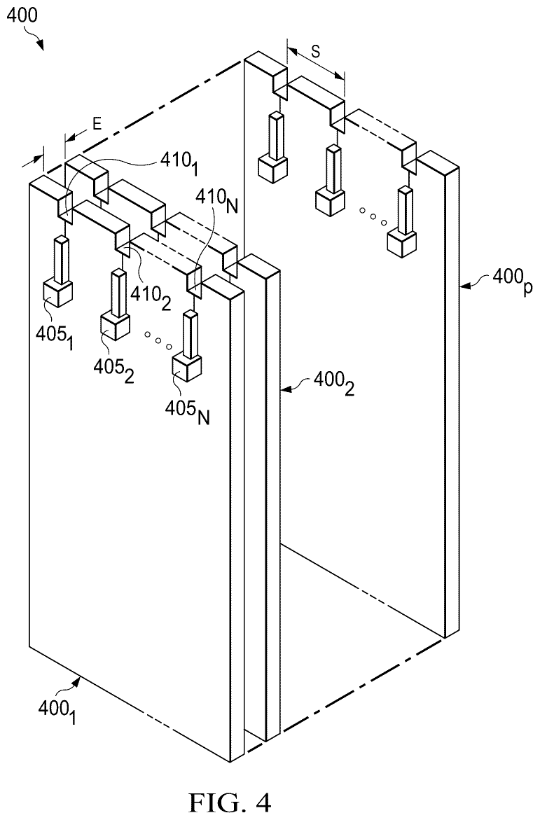

FIG. 4 is a schematic diagram of a two-dimensional array 400 of rectennas, in accordance with another embodiment of the present disclosure. Array 400 of rectennas is shown as including P boards 402ᵢ where i is an index ranging from 1 to P. Each board is shown as including an array of N rectennas each including, in part, a rectifying circuit 405ⱼ, and an associated edge emitting printed circuit board (PCB) antenna 410ⱼ, where j is an index ranging from 1 to N in this example. The pitch/spacing between each pair of adjacent edge emitting antennas positioned on the same board is shown as being equal to S, which in some embodiments is equal to or less than half of the wavelength of the RF signal being received by the array. In one embodiment, the spacing E between each pair of adjacent boards is defined in the same manner as described above with respect to array 200 shown in FIG. 3. In another embodiment, the spacing E between each pair of adjacent boards is between one-twentieth to half of the wavelength of the RF signal being received by the array. In yet another embodiment, the spacing E between each pair of adjacent boards is selected to be inversely proportional to the power density received by array 400, such that the smaller the spacing E, the higher is the RF power received. It is understood that the boards may be held securely in place using any kind of mechanical structure, such as spacers.

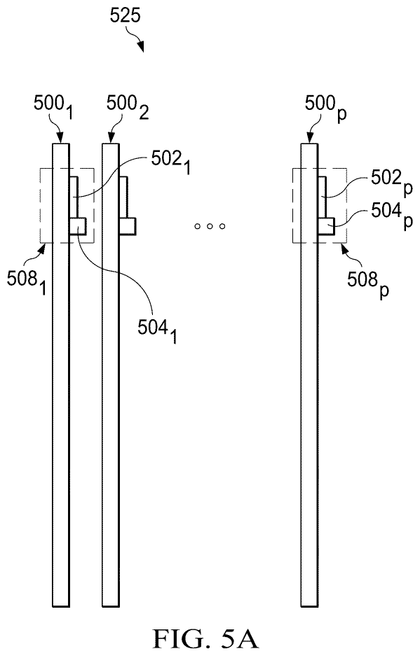

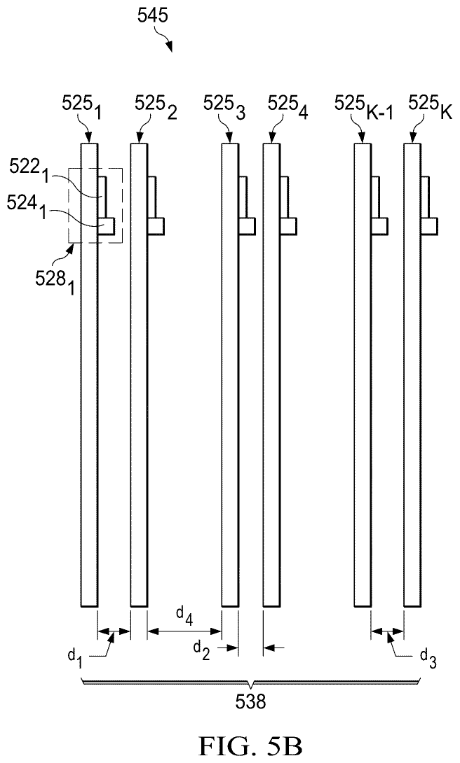

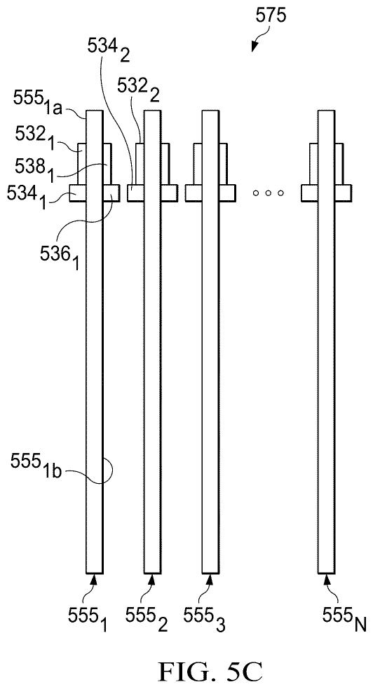

FIG. 5A is a side view of a rectenna array 525, in accordance with one embodiment of the present disclosure. Rectenna array 525 is shown as including P boards 500₁, 500₂ . . . 500_{P} each having a one-dimensional or a two-dimensional array of rectennas, where P is an integer greater than one. For simplicity and to avoid clutter, only one rectenna is shown on each of the boards 500ⱼ, where j in an index ranging from 1 to P. For example, board 500₁ is shown as including antenna 502₁ and rectifying circuit 504₁ together forming rectenna 508₁. In a similar manner, board 500_{P} is shown as including antenna element 502_{P} and rectifying circuit 504_{P} together forming a rectenna 508. In rectenna array 525, the spacing between each pair of adjacent boards 500ⱼ₋₁ and 500ⱼ is the same.

FIG. 5B is a side view of a rectenna array 545, in accordance with another embodiment of the present disclosure. Rectenna array 545 is shown as including K boards 525₁, 525₂ . . . 525_{K} that are parallel to one another to form a stack 538. Each board includes a one-dimensional or a two-dimensional array of rectennas, where K is an integer greater than one. For simplicity and to avoid clutter, only one rectenna is shown on each of the boards 525ⱼ, where j is an index ranging from 1 to K in this example. For example, board 525₁ is shown as including antenna 522₁ and rectifying circuit 524₁ together forming rectenna 528₁. In rectenna array 545, the spacing between one group of adjacent boards is different than the spacing between another group of adjacent boards. For example, the spacing between boards 525₁ and 525₂ is shown as being equal to d₁; the spacing between boards 525₃ and 525₄ is shown as being equal to d₂ which is smaller than d₁, and the spacing between boards 525_{K-1} and 525_{K} is shown as being equal to d₃ which is greater than d₂. The spacing between boards 525₂ and 525₃ is d₄ which may be greater than d₁. Accordingly, in rectenna array 545, the spacing between adjacent boards is smallest near the center of the stack 580 of the boards. The spacing between adjacent boards gets progressively larger away from the center of the stack and toward the end boards of the stack.

FIG. 5C is a side view of a rectenna array 575, in accordance with another embodiment of the present disclosure. Rectenna array 575 is shown as including N boards 555₁, 555₂ . . . 555_{N} that are parallel to one another to form a stack. Each board in array 575 includes a one-dimensional or a two-dimensional array of rectennas positioned one both sides of the board. For simplicity and to avoid clutter, only one rectenna is shown on each side of each boards 555ⱼ, where j is an index ranging from 1 to N this example. For example, board 555₁ is shown as including a rectifying circuit 534₁ housed in a package and adapted to rectify the RF signal received from associated antenna 532₁. Rectifying circuit 534₁ and the associated antenna 532₁ that form a rectenna are disposed on surface 555₁a of board 555₁. Board 555₁ is also as shown as including a rectifying circuit 536₁ housed in a package and adapted to rectify the RF signal received from associated antenna 538₁. Rectifying circuit 536₁ and the associated antenna 538₁ that form a rectenna are disposed on surface 555₁b of board 555₁. In array 575, the rectennas positioned on opposing sides of the same board are spaced apart by the thickness of the board. The spacing between corresponding rectennas positioned on the similar sides of two adjacent boards—such as the spacing between the rectenna that includes antenna 532₁ and rectifying circuit 534₁ of board 555₁ and the rectenna that includes antenna 532₂ and rectifying circuit 534₂ of board 555₂—is defined by the spacing between the two boards, which may be equal to twice the thickness of the packaging of the rectifying circuits if the rectifying circuits occupy the same positions on their corresponding boards. It is understood that the antennas in each board may be any of the edge emitting planar antennas such as dipole, inverted F, Vivaldi, slot antenna, and the like.

The double sided rectenna array shown in FIG. 5C when the spacing between adjacent boards is selected to be one-quarter of the wavelength of the RF signal or smaller (such as one-eight of the wavelength of the RF signal), can recover 8 times more power compared to a one-sided rectenna array in which the spacing between the boards is one-half of the wavelength of the RF signal. The increase in power recovery by a factor of 8 is due, in part, to (i) an increase by a factor 2 in the received power by the differential dipole antennas, (ii) an increase by another factor 2 as a result of the double-sided array of the antennas, and (iii) antenna element spacing that is quarter wavelength of the RF signal. The rectenna array 575 accommodates variable RF power intensity by forming high-power double-sided board arrays near the center of the array, such as near boards 555_{N/2} and 525_{(N/2+1)}(not shown) where the focused RF power has the highest intensity. In another embodiment (not shown), the spacing (pitch) between a pair of adjacent boards is smallest near the center of the board array and gradually increases from the center of the board array toward the ends/edges of the board array. A rectenna array with non-uniform board spacing, as described above, will track the proportional drop-off in RF power intensity from the focal spot of the RF beam, thereby enabling a relatively low-cost and low-weight rectenna array compared to a rectenna array that has a uniform spacing between each pair of its adjacent boards.

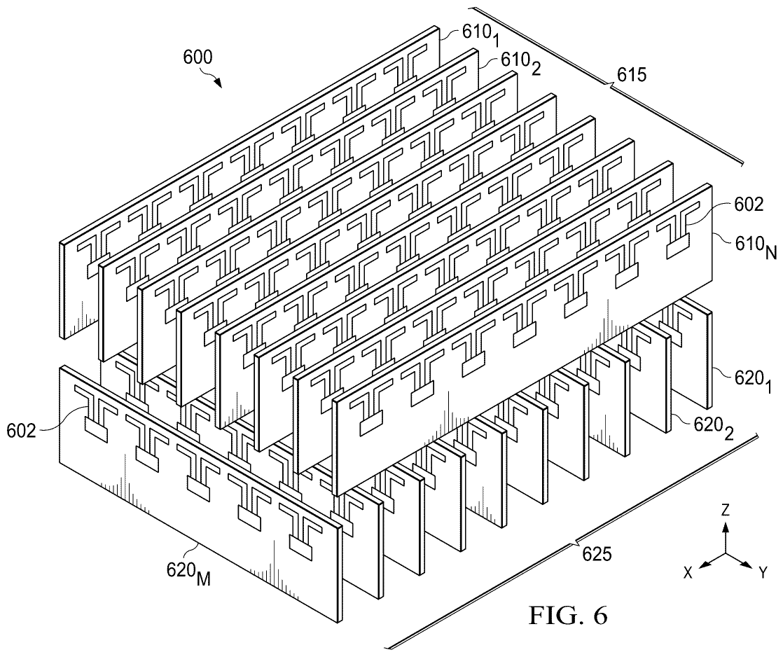

In accordance with some embodiments of the present disclosure, a rectenna array is dual-polarized and includes a first rectenna array and a second rectenna array. The first rectenna array is adapted to receive RF signal having a first polarization direction. The second rectenna array is rotated 90 degrees relative to the first rectenna array, and is adapted to capture cross polarization components of the incident RF signal that pass through the first rectenna array. FIG. 6 is a perspective view of a dual-polarized rectenna array 600 that includes a first rectenna array 615 disposed on a first multitude of boards adapted to receive the RF signals having polarization direction along the x-axis, and a second array 625 disposed on a second multitude of boards and adapted to receive the RF signals having polarization direction along the y-axis.

Rectenna array 615 is shown as having a stack of N boards 610₁, 610₂ . . . 610_{N} each of which may have an array of dipole antennas 602, described in detail with reference to FIG. 2. Rectenna array 615 is also shown as having a stack of M boards 620₁, 620₂ . . . 620_{M} each of which may include an array of dipole antennas 602, where M and N are integers that may or may not be equal to one another. In other embodiments, each of the boards 610ᵢ or 620ⱼ may include a two-dimensional array of edge antennas or other suitable antennas. In the example shown in FIG. 6, rectenna array 615 is shown as being positioned above rectenna array 625. However, in other embodiments, rectenna array 615 may have a different position with respect to rectenna array 625. The antennas disposed on boards 610ᵢ, where i is an index ranging from 1 to N in this example, are adapted to capture the RF signals having polarization direction along the x-axis. The antennas disposed on boards 620ⱼ, where j is an index ranging from 1 to M in this example, are adapted to capture the RF signals having polarization direction along the y-axis.

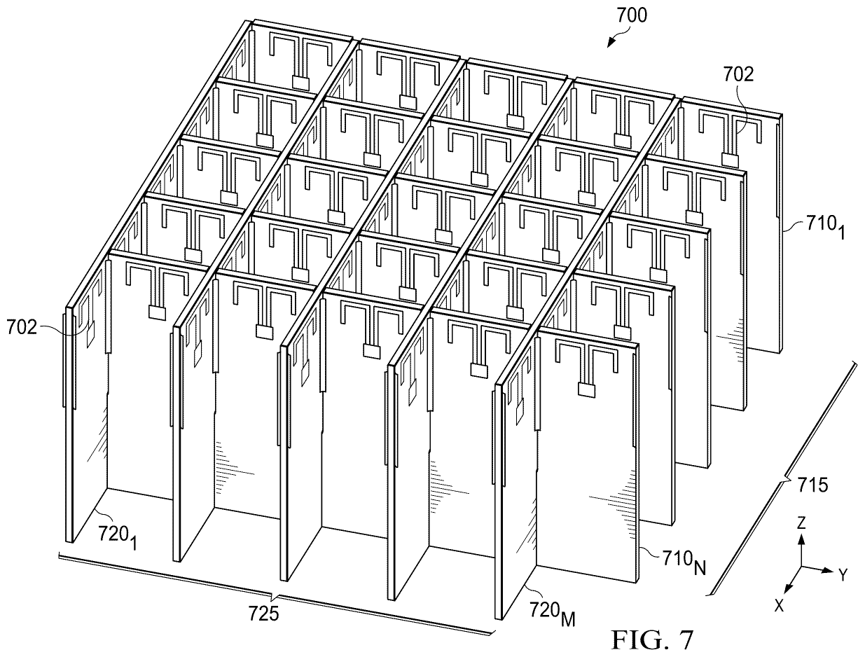

FIG. 7 is a perspective view of a dual-polarized rectenna array 700, in accordance with another embodiment of the present disclosure. Dual-polarized rectenna array 700 is shown as including a first array 715 of boards each having an array of rectennas adapted to capture the RF signals having polarization direction along the y-axis, and a second array 725 of boards each having an array of rectennas adapted to capture the RF signals having polarization direction along the x-axis. Board array 715 is shown as having N boards 710₁, 710₂ . . . 710_{N} each of which may have an array of dipole antennas 702. Board array 725 is shown as having M boards 720₁, 720₂ . . . 720_{M} each of which may have an array of dipole antennas 702. In other embodiments, each of the boards 710ᵢ and 720ⱼ may include a two-dimensional array of edge antennas or other suitable antennas, where i is an index ranging from 1 to N, j is an index ranging from 1 to M, and where N and M may or may not be equal. In dual-polarized rectenna array 700, each board 720ⱼ includes a multitude of slots along the z-axis in which boards 710ᵢ may be inserted. Alternatively, each of boards 715ᵢ may include a multitude of slots along the z-axis in which boards 720ⱼ may be inserted. Because in such embodiments, antennas 702 are in the same plane, rectenna array 700 has an enhanced field of view.

The DC power generated by a multitude of rectifiers in a rectenna array, in accordance with any of the embodiments of the present disclosure, may be connected in parallel, in series, or in a hybrid fashion that combines the series and parallel connection. For example, with reference to the double-sided array, an example of which is shown in FIG. 5C, the output terminals of the rectifiers positioned on a first side of the substrate/board, such as side 555₁a of board 555₁ may be connected in parallel; the output terminals of the rectifiers positioned on a second side of the substrate/board, such as side 555₁b of board 555₁ may be connected in parallel. The parallel outputs from the first side of each board is then connected in series with the parallel outputs from the second side of each board. When the board/substrate used in the rectenna array is relatively thin such that the front and back side antennas are substantially at the same focal spot of the RF energy, the front and back side antennas may capture substantially the same amount of RF power. Accordingly, the output voltages and currents from the front and backside antennas of each board/substrate may be equal and hence can be connected in series.

In one embodiment, the RF power received by each rectenna element—which includes an RF-to-DC rectifier and an antenna element (such as dipole, edge emitting, and the like)—of each board in the rectenna array is delivered to a DC-to-DC converter positioned on the rectenna array. A power tracking algorithm, such as, but not limited to, perturb and observe, or hill ascent may then be used to adjust the DC-to-DC converter output voltage in order to maximize the power extracted from the rectennas. In another embodiment, the combined DC output voltages from the rectenna elements on each board of the rectenna array is delivered to a DC-to-DC converter and subsequently applied to a power tracking algorithm to maximize the power extracted from the rectennas.

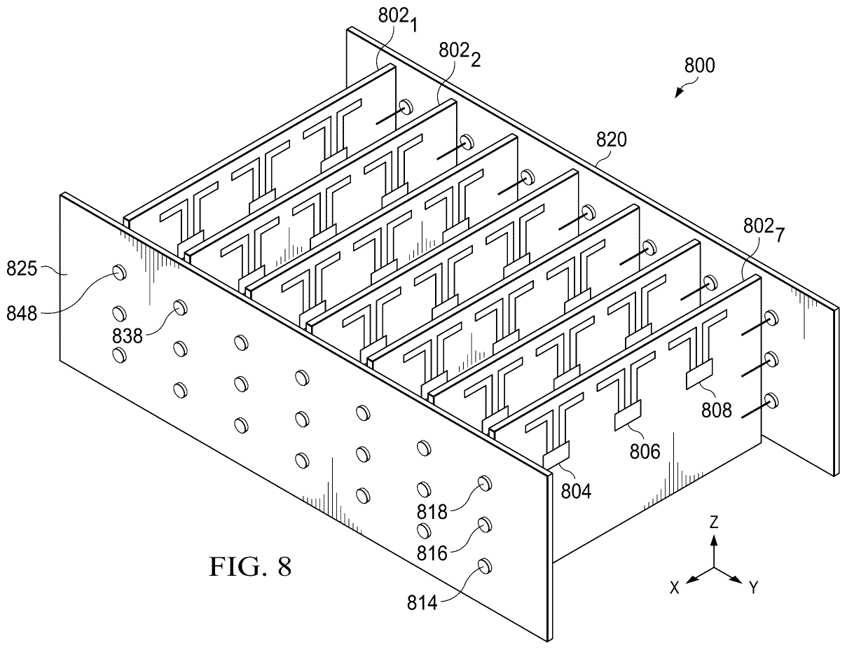

In one embodiment, the RF-to-DC voltages generated by the rectennas in each board of a rectenna array are received from the side edges of the boards. FIG. 8 shows a rectenna array 800 shown as having 7 boards 802ᵢ in which i is an index ranging from 1 to 7. In the example shown in FIG. 8, each board 802ᵢ is shown as having an array of three rectennas 804, 806, 808 each having an associated antenna—shown as being a dipole antenna—and an associated rectifier. In other embodiments, the rectennas in each board may be a two-dimensional array, as shown in the example of FIG. 2. Boards 802ᵢ are shown as being secured to side boards 820 and 825. The DC voltages generated by the rectennas 804, 806 and 810 of board 802 are received by terminals 814, 816 and 818 respectively. The terminals, such as terminals 838 and 848, receive the DC voltages supplied by other rectennas of the array. Side board 820 is similar to side blade 825 and may also include terminals receiving the DC voltages supplied by the rectennas of array 800.

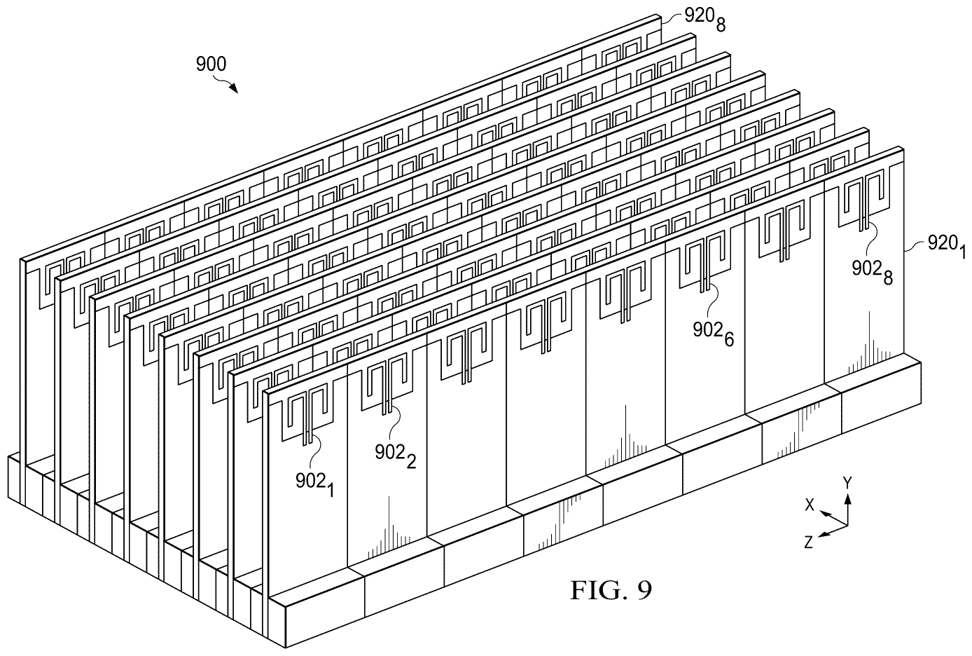

FIG. 9 shows an exemplary rectenna array 900 that includes 8 boards 920ᵢ each having 8 rectennas, where i is an index ranging from 1 to 8 in this example. For example, board 920₁ is shown as including 8 diploe antennas 902₁, 902₂ . . . 902₈. In rectenna array 900, the DC power supplied by each board is received from the back (long) edges of the blades shown as being perpendicular to the x-axis.

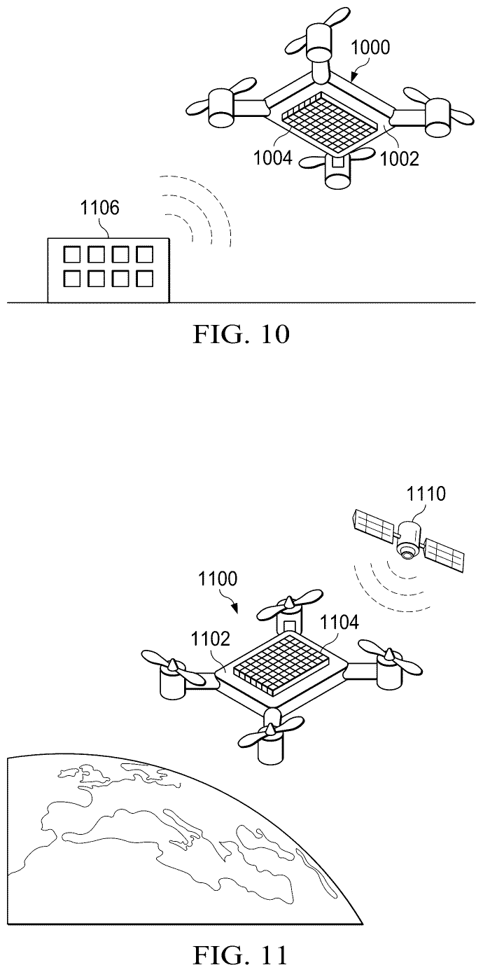

A rectenna array, in accordance with embodiments of the disclosure, may be mounted on a fixed-wing or a multi-rotor (e.g., quadcopter, hexacopter) unmanned aerial vehicle (UAV) to convert RF wireless power—delivered from, for example, a ground-based beamforming transmitter or dish antenna—to a DC voltage to power the UAV. FIG. 10 shows a UAV 1000 that includes a rectenna array 1004 positioned on a bottom surface (i.e., belly) 1002 of the UAV to receive an RF beam from Earth-based transmitter 1106 and covert the received power to DC power. Rectenna array 1004 may correspond to any of the rectenna arrays described above with reference to FIGS. 1-9. FIG. 11 shows a UAV 1100 that includes a rectenna array 1104 positioned on a top surface 1102 of the UAV to receive an RF beam transmitted by one or more satellites 1110 orbiting the earth, and convert the received power to DC voltage to power the UAV. In other embodiments not shown, the UAV may receive an RF beam transmitted by any other RF signal transmitting object positioned above the UAV, such as high-altitude balloons, or RF transmitters stationed above a mountain top having an elevation higher than the UAV's altitude.

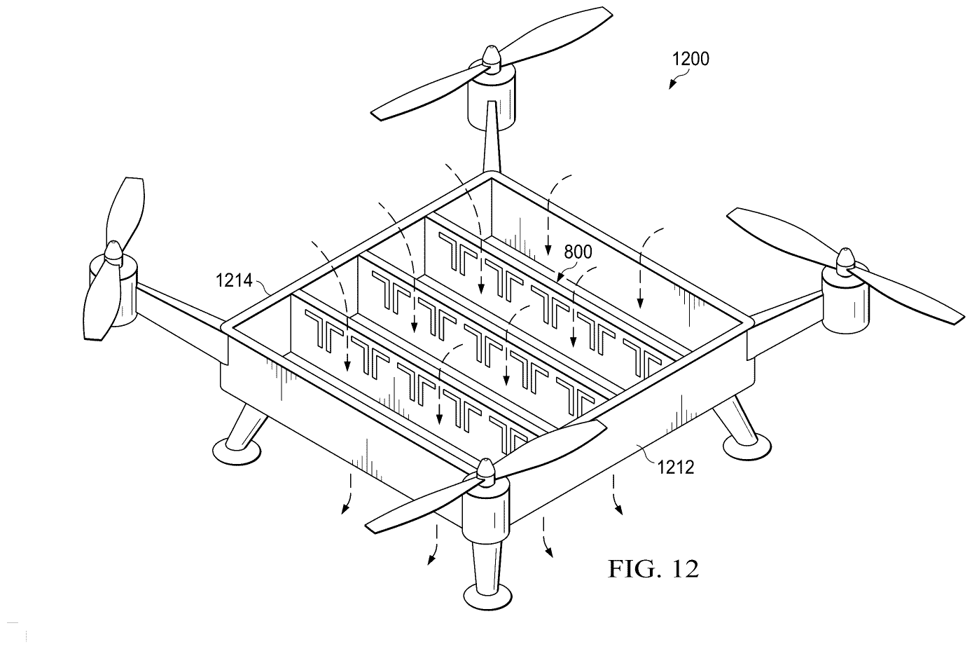

In accordance with some embodiments of the present disclosure, a UAV includes a rectenna array, such as rectenna array 800 shown in FIG. 8, to collect the DC power along the sides of the rectenna array. FIG. 12 shows a UAV 1200 that includes a rectenna array 800 as shown in FIG. 8, to convert a received RF power to DC power and supply the DC power from one or more terminals (not shown) positioned along surfaces 1212 and 1214 of the UAV. The positioning of the rectenna array boards relative to the frame of the UAV enables airflow along the marked arrows from the propellors to cool the rectenna with minimal impact on the airflow or lift.

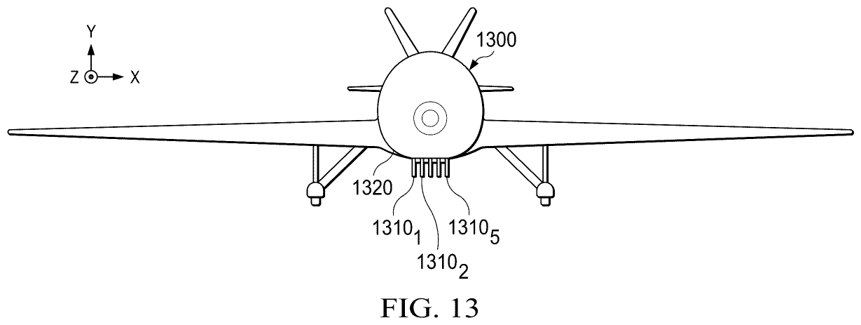

In accordance with some embodiments of the present disclosure, a fixed-wing UAV, such as fixed-wing UAV 1300 shown in FIG. 13, includes a rectenna array 1310 that has DC supply terminals along the back side of the rectenna array facing belly 1320 of the UAV. Exemplary array 1310 is shown as including 5 boards, namely boards 1310₁, 1310₂, 1310₃, 1310₄, 1310₅, each of which has a one-dimensional or a two-dimensional array of rectennas, as described above. Because the terminals of the rectenna array (not shown) face the belly of the UAV, the impact of the DC power collection and delivery to the UAV has a substantially reduced impact on the aerodynamics and drag of the UAV. The airflow from the movement of the aircraft, which is in the z-direction, can be used to cool the rectenna boards.

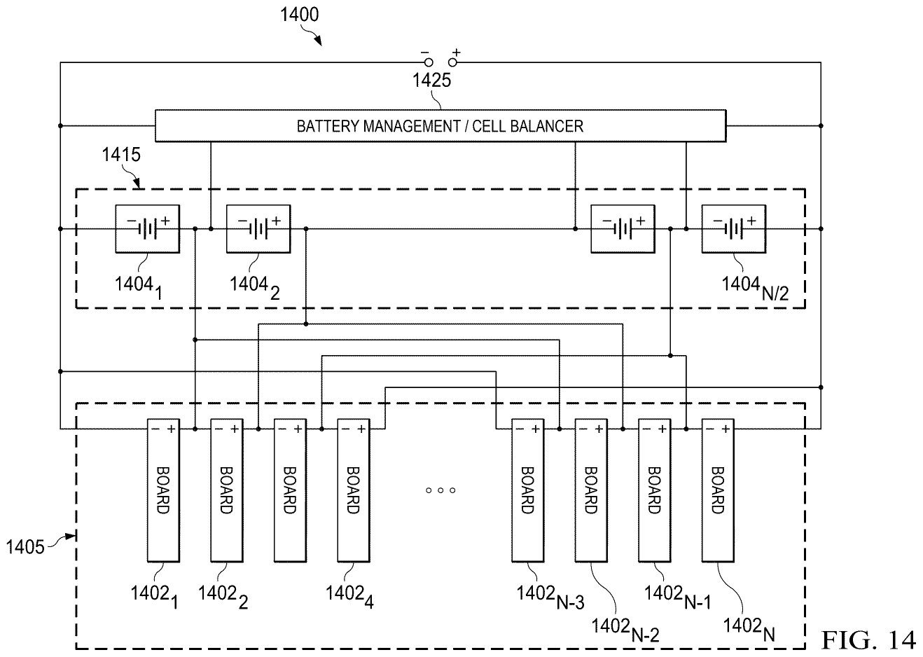

In accordance with another exemplary embodiment of the present disclosure, the battery cells of the UAV can be integrated with the rectenna array boards to provide a uniform weight distribution for the UAV. In such embodiments, each board or a group of boards is associated with and adapted to charge one battery cell independently. A battery management system (BMS) also disposed in the UAV may be programmed to ensure that the battery cells remain balanced. FIG. 14 is a simplified schematic diagram of an exemplary rectenna array 1405, battery cell array 1415, and a battery management/cell balancer 1425 disposed in a UAV (not shown). Rectenna array 1405 is shown as including, in part, N boards 1402₁, 1402₂ . . . 1402_{N-1}, 1402_{N}, where N may be an even integer number. Battery cell array 1415 is shown as including, in part, N/2 battery cells 1404₁, 1404₂ . . . 1402_{N/2}. Each pair of boards is associated with and charges one of the battery cells. For example, boards 1402₁ and 1402_{N-3} are associated with and charge battery 1404₁; and boards 1402₄ and 1402_{N} are associated with and charge battery 1404_{N/2}. Battery cells 1404₁, 1404₂ . . . 1402_{N/2} are shown as being connected in series and controlled by battery management and cell balancer 1425.

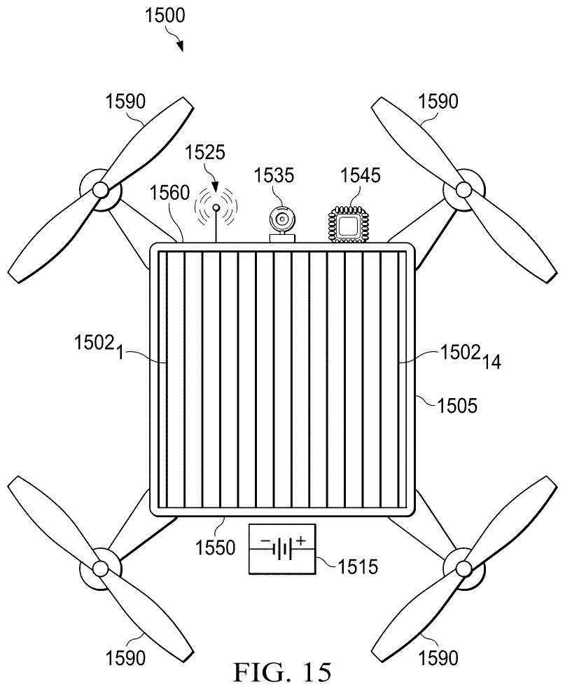

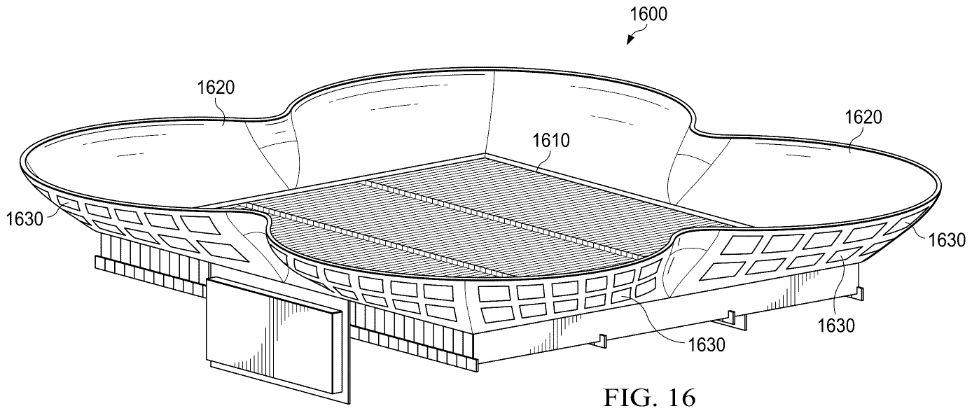

In accordance with another exemplary embodiment of the present disclosure, the rectenna array boards are integrated to form the frame of the multi-rotor UAV. The controllers, radio links, cameras, and the batteries are placed at the edge of the array to allow the air flow to pass through the rectenna array boards for cooling. The propellers may be placed higher or lower than the rectenna array board to allow the air to flow through the rectenna array board. FIG. 15 is a simplified schematic diagram of an UAV 1500 shown as including, in part, a rectenna array 1505, battery cell array 1515 (collectively shown as a battery cell 1515), a wireless communication link 1525, a camera 1535, and a controller 1545. Rectenna array 1505, which is shown as including 14 exemplary boards 1502₁, 1502₂ . . . 1502₁₄, forms the frame of the UAV. Battery cell array 1515 is shown as being positioned along edge 1550 of the UAV; wireless communications link 1525, camera 1535 and controller 1545 are shown as being positioned along edge 1560 of the UAV. By positioning the battery cell array, the wireless communications link, the camera and the controller along the edges of the UAV, as shown, the flow of air from propellers 1590 to board array 1510 is advantageously not disrupted.

In accordance with yet another exemplary embodiment of the present disclosure, a UAV includes a rectenna array formed on a multitude of boards, as well as an array of planar patch antennas. The multitude of boards may be placed near the center of the UAV frame where a relatively higher RF power is concentrated. The array of planar patch antennas may be positioned along the sides of the UAV frame where the RF power intensity is relatively less. The patch antenna array may be formed on a conformal substrate that enables the patch array to be shaped so as to provide optimum airflow by channeling the airflow from the propellers of the UAV toward the rectenna array boards for cooling. FIG. 16 shows a UAV 1600 that includes a rectenna array 1610 boards and a frame 1620 positioned around the rectenna array 1610 boards. Frame 1620 is formed using a conformal substrate along the exterior walls of which an array of patch antennas 1630 is disposed.

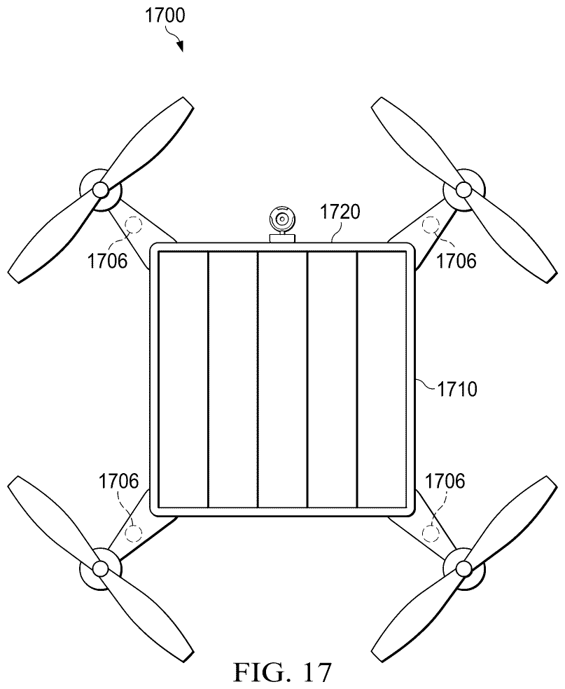

In accordance with another embodiment of the present disclosure, a UAV includes a rectenna array as well as an array of sensors disposed around the rectenna array to measure the RF power intensity around the rectenna array. FIG. 17 shows a UAV 1700 that includes a rectenna array 1710 positioned on a bottom surface 1720 of the UAV to receive an RF beam transmitted by, for example, an Earth-based transmitter. UAV 1700 is also shown as including, in part, a multitude of RF sensors 1706 disposed around the rectenna array to measure the received RF power intensity around the rectenna array 1700.

The outputs of sensors 1706 is fed to the phased array wireless power transmitter (not shown) as a feedback signal so as to enable the wireless power transmitter to move the power beam to the center of the rectenna array 1700. The phased array wireless power transmitter is adapted to move the beam by electronically controlling the phases of the transmit elements to steer the RF beam toward the center of the rectenna array based on the measurements made by sensors 1706. In other embodiments, the transmitter can mechanically move to steer the beam to an optimum position on the rectenna array based on the measurements made by sensors 1706. A number of different control loop algorithms, such as Kalman filters or Proportional-Integral-Derivative (PID) loops may be used to combine the data from the RF sensors to data received other sensors positioned on the UAV to optimize power delivery and flight control of the UAV.

In some embodiments, the measurements made by the sensors is supplied to the UAV's flight controller (not shown) to position the rectenna array at the focal point of the RF beam being received by the rectenna array to power the UAV. The sensors provide information regarding the direction of the movement so as to maintain the rectenna centered to the transmitted RF beam. Accordingly, the UAV remains locked to the transmitted RF beam and will follow the beam as it moves.

The above embodiments of the present invention are illustrative and not limitative. Other additions, subtractions or modifications are obvious in view of the present disclosure and are intended to fall within the scope of the appended claims.

1. A wireless power rectifying system comprising:
a plurality of boards each comprising on a first side thereof an array of antenna elements, and an array of rectifying circuits each associated with a different one of the array of antenna elements and adapted to convert an RF signal received by the associated antenna element to DC voltage, wherein the RF signal has a wavelength λ, wherein each of the rectifying circuits is housed in a package having a height H, wherein a distance between a first one of the plurality of boards and a second one of the plurality boards is in a range defined by (H+λ/20) to (H+λ/2).

2. The wireless power rectifying system of claim 1 wherein the array of antenna elements on each board is a two-dimensional array of dipole antennas.

3. The wireless power rectifying system of claim 1 wherein each board is a printed circuit board (PCB), and wherein the array of antenna elements on each board is a one-dimensional array of edge emitting antennas.

4. The wireless power rectifying system of claim 1 wherein a first subset of the plurality of boards comprises on a second side thereof a second array of antenna elements and a second array of rectifying circuits each associated with a different one of the second array of antenna elements.

5. A wireless power rectifying system comprising:
N boards each comprising on a first side thereof an array of antenna elements, and an array of rectifying circuits each associated with a different one of the antenna elements and adapted to convert an RF signal received by the associated antenna element to a DC voltage, wherein the N boards are arranged in parallel to form a stack, wherein a distance d₁ between first and second of the N boards positioned near a center of the stack is smaller than a distance d₂ between third and fourth of the N boards positioned away from the center of the stack, and wherein the distance d₂ is smaller than a distance d₃ between fifth and sixth of the N boards positioned near either ends of the stack.

6. The wireless power rectifying system of claim 5 wherein the array of antenna elements on each board is a two-dimensional array of dipole antennas.

7. The wireless power rectifying system of claim 5 wherein each board is a printed circuit board (PCB), and wherein the array of antenna elements on each board is a one-dimensional array of edge emitting antennas.

8. A wireless power rectifying system comprising:
a plurality of boards each comprising an array of antenna elements, and an array of rectifying circuits each associated with a different one of the antenna elements and adapted to convert an RF signal received by the associated antenna element to a DC voltage, wherein the RF signal has a wavelength λ, wherein a spacing between each pair of adjacent boards is in a range defined by (λ/20) to (λ/2).

9. The wireless power rectifying system of claim 8 wherein a DC voltage rectified by each rectifier is received along an edge of a board in which the rectifier is disposed.

10. The wireless power rectifying system of claim 8 wherein a DC voltage rectified by each rectifier is received from a backside of a board in which the rectifier is disposed.

11. A wireless power rectifying system comprising:
a first plurality of boards each comprising an array of antenna elements, and an array of rectifying circuits each associated with a different one of the antenna elements and adapted to convert an RF signal received by the associated antenna element to DC voltage, wherein the first plurality of boards is arranged in parallel along a first axis; and
a second plurality of boards each comprising an array of antenna elements, and an array of rectifying circuits each associated with a different one of the antenna elements of the second plurality of boards and adapted to convert an RF signal received by the associated antenna element to DC voltage, wherein the second plurality of boards is arranged in parallel along a second axis substantially perpendicular to the first axis.

12. The wireless power rectifying system of claim 11 wherein the second plurality of boards is positioned either above or below the first plurality of boards.

13. The wireless power rectifying system of claim 11 wherein each antenna of the first and second plurality of boards is a dipole antenna.

14. The wireless power rectifying system of claim 11 wherein each of the second plurality of boards includes a plurality of slots each adapted to receive a different one of the plurality of the first boards.

15. An unmanned aerial vehicle (UAV) comprising a plurality of boards each comprising an array of antenna elements and an array of rectifying circuits each associated with a different one of the antenna elements and adapted to convert an RF signal received by the associated antenna element to DC voltage.

16. The UAV of claim 15 wherein the plurality of boards are positioned below the UAV's body to receive the RF signal transmitted from a ground-based transmitter.

17. The UAV of claim 15 wherein the UAV is a fixed-wing UAV.

18. The UAV of claim 15 wherein the plurality of boards are positioned above the UAV's body to receive the RF signal transmitted from one or more satellites orbiting the earth, or one or more high-altitude balloons, or one or transmitters stationed on one or more high elevation mountain tops.

19. The UAV of claim 15 wherein the UAV further comprises a frame surrounding the plurality of boards, wherein the frame comprises a plurality of patch antennas on the frame's exterior surface.

20. The UAV of claim 15 wherein the UAV further comprises a plurality of sensors each adapted to measure a power of the received RF signal and supply the measured power to a transmitter transmitting the RF signal so as to cause the transmitter to steer the RF signal toward the plurality of boards during flight.

21. The UAV of claim 15 wherein the UAV further comprises a plurality of sensors each adapted to measure a power of the received RF signal, and a flight controller adapted to maintain the UAV locked to a transmitter transmitting the RF signal during flight in accordance with the measurements made by the plurality of sensors.

22. A method comprising:
receiving an RF signal via a plurality of boards, each board comprising on a first side thereof an array of antenna elements and an array of rectifying circuits each associated with a different one of the array of antenna elements, wherein the RF signal has a wavelength λ, wherein each of the rectifying circuits is housed in a package having a height H, wherein a distance between a first one of the plurality of boards and a second one of the plurality is in a range defined by (H+λ/20) to (H+λ/2); and
converting, via each array of the rectifying circuits, the RF signal received by the rectifying circuit's associated array of antenna elements to DC voltage.

23. A method comprising:
receiving an RF signal via a plurality of boards, each board comprising on a first side thereof an array of antenna elements and an array of rectifying circuits each associated with a different one of the array of antenna elements, wherein the RF signal has a wavelength λ, wherein a distance between a first one of the plurality of boards and a second one of the plurality is in a range defined by (λ/20) to (λ/2); and
converting, via each array of the rectifying circuits, the RF signal received by the rectifying circuit's associated array of antenna elements to DC voltage.

24. A method of wirelessly powering an unmanned aerial vehicle (UAV), the method comprising:
receiving an RF signals via a plurality of boards disposed on the UAV, each board comprising an array of antenna elements and an array of rectifying circuits each associated with a different one of the array of antenna elements;
converting, via each array of the rectifying circuits, the RF signal received by the rectifying circuit's associated array of antenna element to DC voltage.

25. The method of claim 24 wherein the array of antenna elements and the associated array of rectifying circuits on each board is a two-dimensional array.
